(19) United States
(12) Patent Application Publication
(10) Pub. No.: US 2026/0087084 A1
(43) Pub. Date: Mar. 26, 2026

(54) METHOD FOR DISPLAYING PAGE TOOL, COMPUTER DEVICE, AND STORAGE MEDIUM

(71) Applicant: Beijing Zitiao Network Technology Co., Ltd., Beijing (CN)

(72) Inventors: Yuqi ZOU, Beijing (CN); Qinqing TAI, Beijing (CN)

(21) Appl. No.: 19/103,796

(22) PCT Filed: Apr. 24, 2024
(86) PCT No.: PCT/CN2024/089568

§ 371 Date: Feb. 13, 2025

(30) Foreign Application Priority Data
May 6, 2023 (CN) 202310506064.8

(51) Int. Cl. G06F 16/9538

(52) U.S. Cl. CPC G06F 16/9538

(57) ABSTRACT

A method for displaying page tool, a computer device, and storage medium are provided. The method includes: obtaining a search result matching search information and a plurality of target tool buttons associated with the search information and/or the search result in response to receiving the search information, wherein the plurality of target tool buttons are determined based on at least one mounting dimension; and displaying the search result and the plurality of target tool buttons in a search result page, and displaying a tool consumption page corresponding to a target tool after the target tool button is triggered.

The present application claims priority to Chinese Patent Application No. 202310506064.8, filed on May 6, 2023, the disclosure of which is hereby incorporated by reference in its entirety as part of the present application.

### TECHNICAL FIELD

The present disclosure relates to a method for displaying a page tool, an apparatus, a computer device, and a storage medium.

### BACKGROUND

With the rapid development of Internet technology, a variety of Internet tools are emerging in an endless stream, such as calendar tools, weather tools, travel tools, and the like. Since the use of various Internet tools has the advantage of not being limited by time and place, great convenience can be brought to users.

However, based on the analysis of users'search needs, it is not difficult to find that the existing tools have deep usage entrances. Especially in search scenarios, users often need to actively search for the tools before they can use the tools, which affects the usage efficiency of the tools.

### SUMMARY

Embodiments of the present disclosure provide at least a method for displaying a page tool, an apparatus, a computer device, and a storage medium.

In a first aspect, an embodiment of the present disclosure provides a method for displaying a page tool, including:
obtaining a search result matching search information and a plurality of target tool buttons associated with the search information and/or the search result in response to receiving the search information, where the plurality of target tool buttons are determined based on at least one mounting dimension; and
displaying the search result and the plurality of target tool buttons in a search result page, and displaying a tool consumption page corresponding to a target tool after the target tool button is triggered.

In a possible implementation, the mounting dimension is determined according to:
determining at least one mounting dimension corresponding to the search result according to a content type of search content in the search result and an association relationship between a preset content type and the mounting dimension.

In a possible implementation, the mounting dimension includes a daily consumption dimension, and the target tool button in the daily consumption dimension is determined according to:
selecting a first tool button from preset tool buttons according to a correlation between a preset tool corresponding to each preset tool button and the search information and/or the search result; and
determining the target tool button from the first tool button according to a usage amount of the preset tool corresponding to each first tool button within a preset time period.

In a possible implementation, the mounting dimension includes a content dimension, and the target tool button in the content dimension is determined according to:
selecting a second tool button from preset tool buttons according to a correlation between a preset tool corresponding to each preset tool button and search content in the search result;
selecting a third tool button matching a historical search behavior from the second tool button according to various historical search behaviors related to the search information and obtained upon authorization;
determining target information flow content with views greater than a preset threshold according to the views of each piece of information flow content within a preset time period; and
selecting the target tool button from the third tool button according to a correlation between each third tool button and the target information flow content.

In a possible implementation, the mounting dimension includes a functional dimension, and the target tool button in the functional dimension is determined according to:
selecting a fourth tool button from preset tool buttons according to a search time period when the search information is input and a pre-established mapping relationship between a time period and a tool button; and
selecting a target tool button with a preset function from the fourth tool button according to a function of a preset tool corresponding to each fourth tool button.

In a possible implementation, after displaying the search result and the plurality of target tool buttons in the search result page, the method further includes:
in response to triggering any one of the target tool buttons, displaying a tool consumption page of a target tool corresponding to the target tool button and displaying an associated tool button associated with the target tool at a preset position of the tool consumption page, where the associated tool button is determined according to a tool category and/or a function of the target tool.

In a possible implementation, the displaying the search result and the plurality of target tool buttons in the search result page includes:
displaying the search result and the target tool buttons in a result display area of the search result page; or
displaying the search result in a result display area of the search result page, and displaying a tool entrance corresponding to each of the target tool buttons in a recommendation area for displaying recommended search terms in the search result page, where the tool entrance is used to replace the recommended search terms displayed in the recommendation area.

In a second aspect, an embodiment of the present disclosure further provides an apparatus for displaying a page tool, including:
an obtaining module configured to obtain a search result matching search information and a plurality of target tool buttons associated with the search information and/or the search result in response to receiving the search information, where the plurality of target tool buttons are determined based on at least one mounting dimension; and
a display module configured to display the search result and the plurality of target tool buttons in a search result page and display a tool consumption page corresponding to the target tool after a target tool button is triggered.

In a third aspect, an optional implementation of the present disclosure further provides a computer device including a processor and a memory. The memory stores machine-readable instructions executable by the processor. The processor is configured to execute the machine-readable instructions stored in the memory. When the machine-readable instructions are executed by the processor, the above first aspect or any possible implementation of the first aspect are executed.

In a fourth aspect, an optional implementation of the present disclosure further provides a computer-readable storage medium. The computer-readable storage medium is stored thereon with a computer program, which, when running, performs the above first aspect or any possible implementation of the first aspect.

For descriptions of effects of the above apparatus for displaying the page tool, the computer device, and the computer-readable storage medium, reference may be made to the description of the above method for displaying the page tool, which will not be repeated here.

In order to make the above objects, features and advantages of the present disclosure more comprehensible, preferred embodiments are described in detail below with reference to the drawings.

### BRIEF DESCRIPTION OF DRAWINGS

In order to more clearly illustrate the technical solutions of the embodiments of the present disclosure, the drawings required for the description of the embodiments will be briefly introduced below. The drawings herein are incorporated in and constitute a part of the present disclosure, and the drawings illustrate the embodiments of the present disclosure and, together with the description, serve to explain the technical solutions of the present disclosure. It should be understood that the following drawings only illustrate some embodiments of the present disclosure, and therefore should not be construed as limiting the scope. For those of ordinary skill in the art, other relevant drawings may be obtained according to these drawings without any creative effort.

FIG. 1 illustrates a flowchart of a method for displaying a page tool according to an embodiment of the present disclosure;

FIG. 2 illustrates a schematic diagram of displaying a search result and target tool buttons in a result display area according to an embodiment of the present disclosure;

FIG. 3 illustrates a schematic diagram of displayed search result and target tool buttons according to an embodiment of the present disclosure;

FIG. 4 illustrates a schematic diagram of displaying a search result and tool entrances according to an embodiment of the present disclosure;

FIG. 5 illustrates a schematic diagram of an apparatus for displaying a page tool according to an embodiment of the present disclosure; and

FIG. 6 illustrates a schematic structural diagram of a computer device according to an embodiment of the present disclosure.

### DETAILED DESCRIPTION

In order to make the objects, technical solutions and advantages of the embodiments of the present disclosure clearer, the technical solutions in the embodiments of the present disclosure will be described clearly and completely below with reference to the drawings in the embodiments of the present disclosure. Obviously, the described embodiments are only a part of the embodiments of the present disclosure, but not all of them. The components of the embodiments of the present disclosure generally described and illustrated herein may be arranged and designed in various different configurations. Therefore, the following detailed description of the embodiments of the present disclosure is not intended to limit the scope of the claimed present disclosure, but merely represents selected embodiments of the present disclosure. Based on the embodiments of the present disclosure, all other embodiments obtained by those skilled in the art without creative effort belong to the protection scope of the present disclosure.

In addition, the terms “first” and “second” in the specification and claims of the embodiments of the present disclosure and in the above-mentioned drawings are used to distinguish similar objects, but not necessarily to describe a specific order or sequence. It should be understood that the data used in this way can be interchanged under appropriate circumstances, so that the embodiments described here can be implemented in a sequence other than those illustrated or described here.

“A plurality of” or “several” as mentioned herein refers to two or more. “And/or” describes an association relationship of associated objects, indicating that there may be three relationships, for example, A and/or B, which may represent: three cases where A exists alone, A and B exist at the same time, and B exists alone. The character “/” generally represents that the associated objects before and after are in an “or” relationship.

Research findings show that based on the analysis of usage demand for various tools, most tools can be applied in various usage scenarios, and there is a strong usage demand for these tools. A conventional tool usage process is mostly that after a user has a need to use a certain tool, the user actively searches for the related tool according to the need, and then uses the found tool to satisfy the corresponding need. However, the way of actively searching for the tool not only affects the usage efficiency of the tool, but also is not conducive to improving the user experience.

Based on the above research, the present disclosure provides a method for displaying page tool, an apparatus, a computer device, and a storage medium. In the method, while obtaining a search result, a plurality of target tool buttons associated with search information and/or the search result are obtained, and the search result and the search tool buttons are displayed in a search result page at the same time. Thus, the linkage display of the search result and search tools can be realized firstly. In addition, since the target tool buttons are buttons associated with the search information and/or the search result, the target tool corresponding to each of the target tool buttons may be tool that has a strong correlation with the search information and the search result, and such tool is often tool that needs linkage usage after a search operation corresponding to the search information is initiated. Therefore, by displaying the search result and the search tool buttons in the search result page at the same time, a linkage usage demand for various tools can be better satisfied, and the tool usage experience and usage efficiency can be improved. Secondly, since the tool consumption page corresponding to the target tool can be displayed after the search tool button is triggered, the target tool can be used through the search tool button in the search result page, without the need to use the tool by actively searching for or finding the tool, which shortens the usage path of the tool and improves the usage efficiency of the tool.

The defects of the above solutions are the results obtained by the inventors after practice and careful study. Therefore, the discovery process of the above problems and the solutions proposed by the present disclosure to the above problems below should be the contributions of the inventors to the present disclosure during the process of the present disclosure.

It should be noted that similar reference numerals and letters in the following drawings represent similar items. Therefore, once an item is defined in one drawing, there is no need to further define and explain it in subsequent drawings.

It can be understood that before using the technical solutions disclosed in the embodiments of the present disclosure, users should be informed of the type, usage scope, usage scenarios, etc. of personal information involved in the present disclosure in an appropriate manner, and the authorization of the users should be obtained, in accordance with relevant laws and regulations.

To facilitate understanding of the embodiments, a method for displaying a page tool disclosed in an embodiment of the present disclosure will be described in detail first. The execution body of the method for displaying the page tool according to the embodiment of the present disclosure is generally a terminal device or other processing device with a certain computing capability, where the terminal device may be a user equipment (UE), a mobile device, a user terminal, a terminal, a personal digital assistant (PDA), a handheld device, a computer device, or the like. In some possible implementations, the method for displaying the page tool may be implemented by a processor calling computer-readable instructions stored in a memory.

The method for displaying the page tool according to the embodiments of the present disclosure will be described below with an execution body being a client as an example.

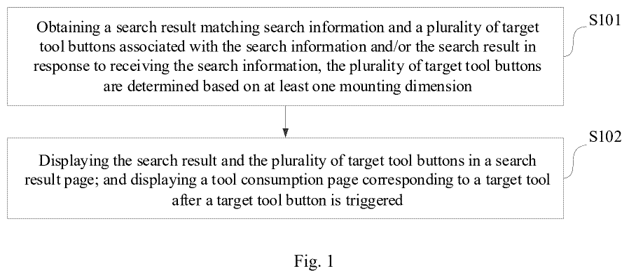

As shown in FIG. 1, which is a flowchart of a method for displaying a page tool according to an embodiment of the present disclosure, the method may include:

In S101, obtaining a search result matching search information and a plurality of target tool buttons associated with the search information and/or the search result in response to receiving the search information, where the plurality of target tool buttons are determined based on at least one mounting dimension.

Here, the search information may specifically be a search term, a search statement, or the like with any length input by a user. For example, the search information may be weather, scenic spots, XX novels, XX news, XX videos, and the like. The search result is content matching the search information found by using a search engine. The search result may be a result in any form, for example, the search result may be a natural result, a result card, a vertical search result, or the like, and the search result may include one or more.

One target tool button corresponds to one target tool. By triggering the target tool button, a tool consumption page of the target tool corresponding to the button can be accessed, and then the target tool corresponding to the button can be used on the tool consumption page. Different target tools can provide different services and have different functions. For example, a weather tool with a function of viewing the weather, a taxi tool with a taxi-hailing function, a travel tool with a ticket booking function, a calendar tool with a calendar viewing function, and a navigation tool with a navigation function. The target tool button may be a button related to at least one of the search information and the search result.

The mounting dimension may represent a tool attribute of a tool that needs to be mounted, and may be used to select, from preset tools, a target tool that needs to be mounted on a search result page together with a search result. The preset tool may be any tool that a user is allowed to use. The mounting dimension may be determined according to the search information and/or the search result, or may be preset according to experience. Alternatively, the mounting dimension may be determined according to views of each piece of information flow (i.e., a feed) content within a preset historical time period, sorting the information flow content in an order of the views from high to low, and then determining a common content attribute of the information flow content whose ranking order is higher than a preset order. The plurality of target tool buttons that are obtained may be determined based on one or more mounting dimensions.

Specifically, the mounting dimension may include, for example, a daily consumption dimension, a content dimension, a functional dimension, a tool usage frequency dimension, and the like. The tools in the daily consumption dimension may be tools with a relatively high usage frequency, the tools in the content dimension may be tools with a relatively high correlation with the search information or the search result, and the tools in the functional dimension may be tools with a preset function indicated by the functional dimension.

For example, in response to receiving the search information, the search information may be sent to a server, which may determine, using a search engine, the search result matching the search information. Meanwhile, the server may determine at least one mounting dimension, and then determine, according to the mounting dimension, target tool buttons corresponding to a plurality of target tools that can be displayed, according to the search information and/or the search result. Then, the server may feed back the search result and the target tool buttons to the client. In this way, the client can obtain the search result matching the search information and the plurality of target tool buttons associated with the search information and/or the search result.

For example, in addition to determining the target tool button based on the mounting dimension, the target tool button may also be determined based on the usage amount of the consumption behavior and/or each target tool obtained upon authorization, where the consumption behavior may include a pre-and-post search behavior related to the search information obtained historically, a search behavior related to a search result matching the search information obtained historically, and the like.

Alternatively, in a case where the mounting dimension includes a plurality of preset mounting dimensions, target tools respectively matching the respective preset mounting dimensions may be selected from a large number of preset tools, and a tool button corresponding to the target tool is used as the target tool button.

In an embodiment, the mounting dimension may be determined according to:
determining at least one mounting dimension corresponding to the search result according to a content type of search content in the search result and an association relationship between a preset content type and the mounting dimension.

Here, the preset association relationship is used to indicate the correspondence between various content types and associated mounting dimensions, and one content type may be associated with at least one mounting dimension.

The search content is multimedia content included in the search result, and the content type is used to represent a type of the search content. For example, the content type may include an article type, a tool type, a video type, and the like.

For example, a plurality of mounting dimensions may be preset, and an association relationship between each content type and the mounting dimension may be pre-established. For example, for the article type, an association relationship between the article type and a correlation dimension and a daily consumption dimension may be pre-established. For the tool type, an association relationship between the tool type and a functional dimension and a tool usage frequency dimension may be pre-established. After obtaining the search result, a content type of the search content in the search result may be determined, and then the mounting dimension corresponding to the search result may be determined according to the association relationship corresponding to the content type. Then, a target tool button matching the mounting dimension may be selected from preset tool buttons according to the mounting dimension.

In an embodiment, the mounting dimension may include the daily consumption dimension, and the tools in the daily consumption dimension may be tools that are frequently used on a daily basis, such as weather tools, calendar tools, travel tools, shopping tools, takeout tools, express delivery tools, moving tools, maintenance tools, education and training tools, number query tools, health service tools, etc. The target tool button may be determined according to:
Step 1, selecting a first tool button from preset tool buttons according to a correlation between a preset tool corresponding to each preset tool button and the search information and/or the search result.

Here, the preset tool may be any tool with usage permission, one preset tool corresponds to a unique preset tool button, and the preset tool button is used to trigger the preset tool.

In specific implementation, for each preset tool button, a correlation between the preset tool corresponding to the preset tool button and the search information may be determined according to a function of the preset tool corresponding to the preset tool button and text or semantic information of the search information. Then, a preset tool with a correlation greater than a preset correlation threshold is used as a target tool, and a preset tool button corresponding to the target tool is used as the selected first tool button.

Alternatively, for each preset tool button, a correlation between the preset tool corresponding to the preset tool button and the search content may be determined according to a function of the preset tool corresponding to the preset tool button and text or semantic information of the search content. Then, a preset tool with a correlation greater than a preset correlation threshold is used as a target tool, and a preset tool button corresponding to the target tool is used as the selected first tool button.

Alternatively, for each preset tool button, a first correlation between the function of the preset tool corresponding to the preset tool button and the search information may be calculated according to the function of the preset tool corresponding to the preset tool button and text or semantic information of the search information. At the same time, a second correlation between the preset tool corresponding to the preset tool button and the search content may be determined according to the function of the preset tool corresponding to the preset tool button and text or semantic information of the search content. A target correlation corresponding to the preset tool is determined according to an average value of the first correlation and the second correlation. A preset tool with a corresponding target correlation greater than a preset correlation threshold is used as a target tool, and a preset tool button corresponding to the target tool is used as the selected first tool button.
Step 2, determining the target tool button from the first tool button according to a usage amount of the preset tool corresponding to each first tool button within a preset time period.

Here, the preset time period may be a preset historical time period, and the usage amount within the preset time period is used to represent a usage intensity of the preset tool.

In specific implementation, a ranking order corresponding to each first tool button may be determined according to a usage amount of the preset tool corresponding to each first tool button within the preset time period, in an order of usage amount from high to low, and a first tool button with a ranking order higher than a preset order is used as the target tool button.

In this way, the correlation is used to select the target tool button, and the target tool button with a high degree of fit with the search result and the search content can be selected from the preset tool buttons. By displaying the target tool button with a high correlation, the rationality of the displayed target tool button can be improved.

In an embodiment, the mounting dimension may include the content dimension, and determining the target tool button may be implemented according to:
S1, selecting a second tool button from preset tool buttons according to a correlation between a preset tool corresponding to each preset tool button and search content in the search result.

For example, the correlation between each preset tool and the search content may be determined according to the name (or semantics) of the preset tool corresponding to each preset tool button and the text (or semantics) of the search content in the search result. Then, a preset tool with a correlation greater than a preset correlation threshold may be selected from the preset tools as a target tool, and a preset button corresponding to the target tool is used as the second tool button.

For example, the second tool button may be directly used as the target tool button.
S2, selecting a third tool button matching a historical search behavior from the second tool button according to various historical search behaviors related to the search information and obtained upon authorization.

Here, the historical search behavior is a behavior obtained upon user authorization, and may specifically include a pre-and-post search behavior corresponding to the search information, a usage behavior of a search result related to the search information, and the like. The pre-and-post search behavior may be a search behavior before searching with the search information historically and a search behavior after searching with the search information historically. For example, in a case where the search information is the weather, after obtaining the corresponding search result, there may be a post-search behavior of searching for a travel tool, a post-search behavior of searching for a dressing tool, and a post-search behavior of searching for a travel guide. For example, in a case where the search information is a tax rate, after obtaining the corresponding search result, there may be a post-search behavior of searching for a tax rate calculation tool. For another example, in a case where the search information is a certain scenic spot, before obtaining the corresponding search result, there may be a pre-search behavior of searching for a travel tool and a pre-search behavior of searching for a travel guide.

For example, a preset tool respectively matching the respective historical search behavior may be selected from the preset tool corresponding to the second tool button according to the various historical search behaviors related to the search information and obtained upon authorization, and a preset tool button corresponding to the matched preset tool is used as a third tool button.

For example, the selected third tool button may be directly used as the target tool button.
S3, determining target information flow content with views greater than a preset threshold according to views of each piece of information flow content within a preset time period.

For example, the information flow content may be various pieces of information content in the feed, and the target information flow content with views greater than the preset threshold may be the information flow content which is currently highly searched for.

For example, the target information flow content with views greater than the preset threshold may be determined according to the views of each piece of information flow content within the preset time period.

Alternatively, relevant information flow content may be selected from each piece of information flow content according to a content similarity between each piece of information flow content and the search content. Then, the relevant content in the information flow with a number of views greater than the preset threshold may be used as the target information flow content.

In an implementation, when browsing the information flow content in the feed on a feed page, a target tool matching the information flow content may also be selected from preset tools according to a correlation between the information content and each preset tool, and a target tool button corresponding to the target tool is displayed at a preset position of the feed page.
S4, selecting the target tool button from the third tool button according to a correlation between each third tool button and the target information flow content.

Here, the correlation between the third tool button and the target information flow content may be a correlation between a preset tool corresponding to the third tool button and the target information flow content.

In specific implementation, the correlation between each third tool button and the target information flow content may be calculated according to the function of each third tool button and content information of the target information flow content. Then, the third tool buttons may be sorted according to the correlation, and a third tool button with a ranking order higher than a preset order is used as the target tool button. Alternatively, a third tool button with a correlation greater than a preset correlation threshold may be used as the target tool button.

In this way, the selected target tool buttons in the content dimension are tool buttons that have a high correlation with the target information flow content, and such tool buttons may have a high usage demand. Therefore, the rationality of the displayed tool buttons can be improved by displaying such tool buttons.

In an embodiment, the mounting dimension may further include a functional dimension, and the target tool button may be determined according to:
selecting a fourth tool button from preset tool buttons according to a search time period when the search information is input and a pre-established mapping relationship between a time period and a tool button; and
selecting a target tool button with a preset function from the fourth tool button according to a function of a preset tool corresponding to each fourth tool button.

Here, the preset time period may be set according to experience, which is not specifically limited in the embodiment of the present disclosure. For example, the preset time period may include a morning time period, a noon time period, an afternoon time period, and a night time period. The preset function may be set according to experience, which is not specifically limited in the embodiment of the present disclosure. For example, the preset function may be an entertainment function, a learning function, or the like.

Specifically, the usage amount of the preset tool corresponding to each preset tool button within a plurality of preset time periods may be counted in advance. Then, for each preset time period, preset tools with a ranking order of usage amount in the top (for example, the ranking order of usage amount is in the top 10) may be selected according to the usage amount of each preset tool within the preset time period, and a mapping relationship between the preset tool button corresponding to the selected preset tool and the preset time period is established.

Then, after obtaining the search information, the search time period of the search information may be determined, and each preset tool button corresponding to the search time period is determined according to the mapping relationship corresponding to the search time period. Each preset tool button corresponding to the search time period is used as the fourth tool button selected from the preset tool buttons.

For example, the fourth tool button may be directly used as the selected target tool button.

After obtaining the fourth tool button, a fourth tool button corresponding to a preset tool with a preset function may be further used as the selected target tool button according to the function of the preset tool corresponding to each fourth tool button.

For example, after obtaining the fourth tool button, respective fourth tool buttons whose corresponding preset tool has an entertainment function may be used as the selected target tool button.

For example, in a case where the mounting dimension is the functional dimension, a preset tool button whose corresponding preset tool has the preset function may also be directly used as the target tool button.

It can be understood that one or more of the above daily consumption dimension, content dimension, and functional dimension may be used when determining the target tool button. For example, in a case where a plurality of mounting dimensions are used, target tool buttons in the respective mounting dimensions may be determined respectively, and the target tool buttons in the respective mounting dimensions may all be used as target tool buttons that need to be displayed. Alternatively, in a case where a plurality of mounting dimensions are used, a preset tool button that satisfies the plurality of mounting dimensions at the same time may be used as the target tool button.

For example, target tool buttons in the content dimension and/or the daily consumption dimension may be mounted under the search content of the article type, and target tool buttons in the preset function dimension may be mounted under the search content of the tool type.

S102, displaying the search result and the plurality of target tool buttons in a search result page, and displaying a tool consumption page corresponding to a target tool after a target tool button is triggered.

Here, the search result page is a page for displaying the search result. The tool consumption page is a page for using the target tool, and various functions and function buttons of the target tool may be displayed therein. For example, the search result page may also be a result details page corresponding to the search result.

In specific implementation, after obtaining the search result and the plurality of target tool buttons, the search result may be displayed in a first preset area of the search result page, and the respective target tool buttons may be displayed in a second preset area of the search result page. The second preset area may be a bottom area of the search result page, and the first preset area may be, for example, an area of the search result page other than the bottom area. The display order of the respective target tool buttons may be determined according to the usage frequency of the target tool corresponding to the target tool button, or may be determined according to the average value of the matching degree between the target tool corresponding to the respective target tool buttons and the search information and the search content.

In this way, by displaying the search result and the plurality of target tool buttons in the search result page, the linkage usage demand for the tool that may exist after the user searches can be better satisfied, and the search experience of the user can be improved.

For example, in a case where the search result is a tax rate news content, by displaying the tax rate news content and a target tool button (such as a tax rate calculation tool) associated with the tax rate news content in the search result page, the potential need of the user to use the tax rate calculation tool can be satisfied, and the problem that the user needs to search for the tax rate calculation tool again to calculate the tax rate after browsing the tax rate news content can be avoided, which shortens the usage path of the tax rate calculation tool and improves the search experience of the user.

For example, after displaying the search result and the plurality of target tool buttons, a result details page of the search result may also be displayed in response to a trigger operation on the search result, and the plurality of target tool buttons may be displayed on the result details page.

For another example, in a case where the search result page is a result details page corresponding to the search result, the search content corresponding to the search result may be directly displayed in the search result page, and the plurality of target tool buttons may be displayed in the search result page.

In a case where a plurality of search results exist, each search result may be displayed in the search result page, and a plurality of preset tool buttons corresponding to the search result may be displayed below each search result.

In an embodiment, for the above S102, when displaying the search result and the plurality of target tool buttons, any of the following two ways may be used:
Way 1, displaying the search result and the target tool buttons in a result display area of the search result page.

Here, the result display area is an area preset in the search result page for displaying the search result.

For example, the search result and the target tool buttons may be displayed in the result display area according to a display position relationship between the search result and the target tool buttons which is preset. For example, the display position relationship may be that the display position of the search result is located above the display button of the target tool button.

In a case where a plurality of search results exist, each search result may have a plurality of corresponding target tool buttons.

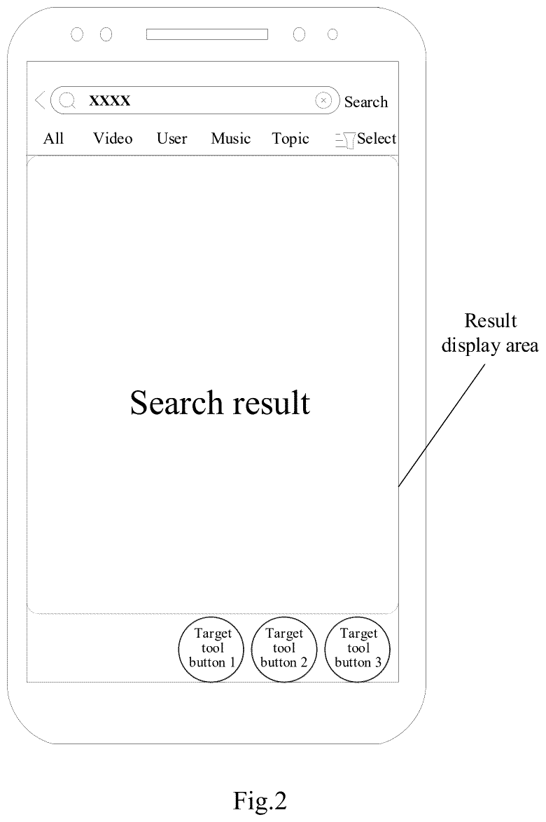

As shown in FIG. 2, which is a schematic diagram of displaying a search result and target tool buttons in a result display area according to an embodiment of the present disclosure, the search information is XXXX, the target tool buttons may include target tool buttons 1 to 3, and the search result is displayed above the plurality of target tool buttons.

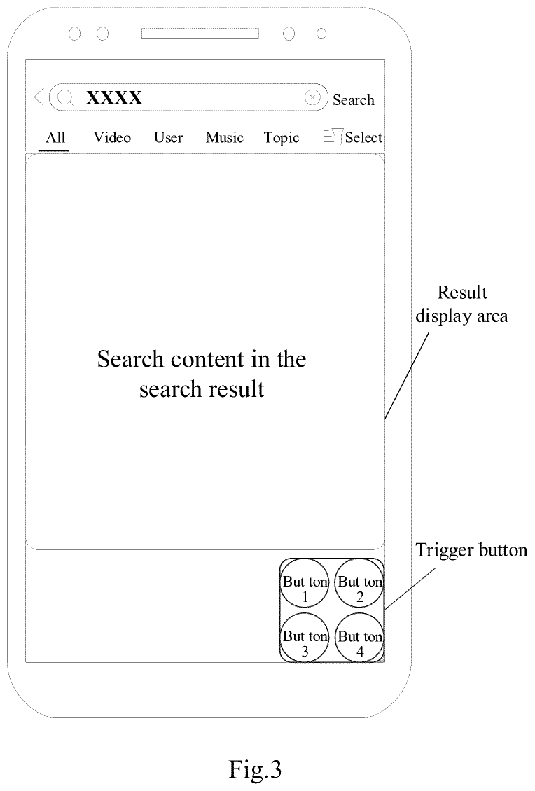

For example, after determining the plurality of target tool buttons, a trigger button may also be set for the plurality of target tool buttons, and the respective target tool buttons may be displayed in the trigger button. When displaying the search result and the target tool buttons, the search result may be displayed in the result display area, and the trigger button may be displayed at a preset position (for example, lower right corner, lower left corner, etc.) of the result display area. As shown in FIG. 3, which is a schematic diagram of displayed search result and target tool buttons according to an embodiment of the present disclosure, the search information is XXXX, the search content in the search result is displayed in the result display area, the target tool buttons include 4 (that is, buttons 1 to 4 in FIG. 3), and the trigger button including the 4 target tool buttons is displayed at the lower right corner of the result display area. After displaying the trigger button, a tool button pop-up window may be generated and displayed in response to clicking on the trigger button, and the 4 target tool buttons are displayed in the tool button pop-up window. Alternatively, a tool button page may be generated and displayed in response to clicking on the trigger button, and the 4 target tool buttons are displayed in the tool button page. At the same time, a plurality of preset tool buttons with a high usage amount or a plurality of preset tool buttons which are pre-specified may also be displayed in the tool button page.
Way 2, displaying the search result in a result display area of the search result page, and displaying a tool entrance corresponding to each of the target tool buttons in a recommendation area for displaying recommended search terms in the search result page, where the tool entrance is used to replace the recommended search terms displayed in the recommendation area.

Here, the recommendation area for the search recommended terms is an area for displaying the search recommended terms related to the current search. The tool entrance may specifically be the target tool button itself, a tool link, a tool icon, a tool identification, a tool name, etc., or may be a combination of one or more of the target tool button itself, the tool link, the tool icon, the tool identification, and the tool name. After the tool entrance is triggered, a tool consumption page of the target tool indicated by the target tool button corresponding to the tool entrance may be displayed. The tool entrance is used to replace the recommended search term displayed in the recommendation area, that is, one tool entrance occupies a display position of one search recommended term.

For example, after obtaining the search result and the plurality of target tool buttons, tool entrances respectively corresponding to the plurality of target tool buttons may be determined. Then, the search result may be displayed in the result display area of the search result page, and the respective search recommended terms in the recommendation area may be replaced with the tool entrances corresponding to the target tool buttons, to display the plurality of target tool buttons.

It can be understood that in a case where the number of search recommended terms is greater than the number of target tool buttons, the search recommended terms in the recommendation area may be replaced with the tool entrances respectively corresponding to the plurality of target tool buttons. At the same time, the search recommended terms that have not been replaced may continue to be displayed in the recommendation area. The search recommended term that needs to be replaced with the tool entrance may be determined from the search recommended terms according to a recommendation index of the respective search recommended term.

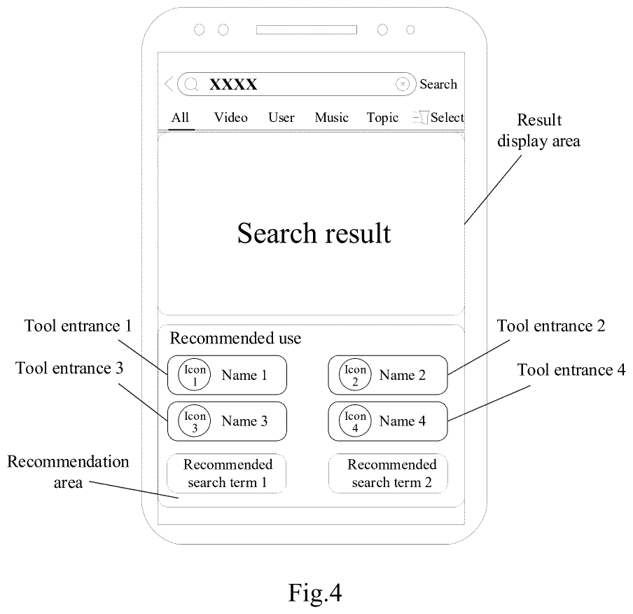

As shown in FIG. 4, which is a schematic diagram of displaying a search result and tool entrances according to an embodiment of the present disclosure, the search result is displayed in the result display area, the target tool buttons include 4, and the tool entrances corresponding to the respective target tool buttons are a combination of the tool name and the tool icon corresponding to the target tool button (such as tool entrances 1 to 4 in FIG. 4). The 4 tool entrances are displayed in the recommendation area, and two unreplaced search recommended terms (that is, search recommended term 1 and search recommended term 2 in FIG. 4) are also displayed in the recommendation area.

In an implementation, the target tool button may also be determined according to the following steps: determining a display way of the tool button that needs to be used (that is, the above way 1 or way 2), and then determining the mounting dimension corresponding to the display way according to a preset association relationship between the display way and the mounting dimension. Then, the target tool button may be selected from the preset tool buttons according to the mounting dimension corresponding to the display way. After obtaining the search result, the search result and the target tool button may be displayed in the search result page according to the display way.

In an embodiment, after displaying the search result and the plurality of target tool buttons in the search result page, the following step may also be performed:
in response to triggering any one of the target tool buttons, displaying a tool consumption page of a target tool corresponding to the target tool button and an associated tool button associated with the target tool at a preset position of the tool consumption page, where the associated tool button is determined according to a tool category and/or a function of the target tool.

Here, the preset position may be a page bottom position, a side position, or the like of the tool consumption page. The tool consumption page is a page for consuming the target tool. The tool category may include, for example, education and training, life services, travel, health services, entertainment, dedicated tools, etc. The operation of triggering the target tool button may be, for example, an operation of clicking on the target tool button.

In specific implementation, after displaying the target tool button in the search result page, a tool consumption page of the target tool corresponding to the triggered target tool button may also be generated and displayed in response to triggering any displayed target tool button. At the same time, at least one associated tool button associated with the target tool may be determined, and the at least one associated tool button is displayed at a preset position of the tool consumption page.

The associated tool button may be determined as follows:
determining respective associated tools in the same category as the target tool according to a tool category of the target tool, and using a tool button corresponding to the associated tool as the associated tool button. Alternatively, respective associated tools with the same or similar functions as the target tool may be determined according to a function of the target tool, and a tool button corresponding to the associated tool is used as the associated tool button. Alternatively, an initial tool in the same category as the target tool may be determined according to a tool category of the target tool; then respective associated tools with the same or similar functions as the initial tool are determined according to a function of the initial tool; finally, a tool button corresponding to the associated tool may be used as the associated tool button. Alternatively, a preset mounting dimension for the associated tool button may be determined. Then, an initial tool may be determined according to a tool category and/or a function of the target tool. Then, an initial tool matching the mounting dimension for the associated tool button is selected from the initial tool according to the mounting dimension for the associated tool button, and the selected initial tool is used as the associated tool. Finally, a tool button corresponding to the associated tool may be used as the associated tool button.

In this way, by displaying the associated tool button on the tool consumption page, the linkage usage demand for other tools that may exist after the user consumes the target tool can be better satisfied, thereby improving the search experience of the user.

For example, after the target tool button triggered by the user is a travel tool button, associated tool buttons such as a tool button of a travel tool provided by a different platforms, a tool button corresponding to a scenic spot search tool, a plurality of tool buttons corresponding to a hotel reservation tool, a tool button of a weather tool, etc. may be displayed on the tool consumption page corresponding to the travel tool button, which can better satisfy the user's linkage usage demand for other tools and improve the user's search experience.

Based on the above embodiments, while obtaining a search result, a plurality of target tool buttons associated with search information and/or the search result are obtained, and the search result and the search tool buttons are displayed in a search result page at the same time. Thus, the linkage display of the search result and search tools can be realized firstly. In addition, since the target tool buttons are buttons associated with the search information and/or the search result, the target tools corresponding to the respective target tool buttons may be tools that have a strong correlation with the search information and the search result, and such tools are often tools that need to be used in conjunction after a search operation corresponding to the search information is initiated. Therefore, by displaying the search result and the search tool buttons in the search result page at the same time, the linkage usage demand for various tools can be better satisfied, and the tool usage experience and usage efficiency can be improved. Secondly, since the tool consumption page corresponding to the target tool can be displayed after the search tool button is triggered, the target tool can be used through the search tool button in the search result page, without the need to use the tool by actively searching for or finding the tool, which shortens the usage path of the tool and improves the usage efficiency of the tool.

It can be understood by those skilled in the art that in the above method in the specific implementations, the writing sequence of the steps does not mean a strict execution sequence and does not constitute any limitation to the implementation process. The specific execution sequence of the steps should be determined according to their functions and possible internal logic.

Based on the same inventive concept, an apparatus for displaying a page tool corresponding to the method for displaying the page tool is further provided in an embodiment of the present disclosure. Since the principle for the apparatus in the embodiment of the present disclosure to solve problems is similar to that of the above method for displaying the page tool in the embodiment of the present disclosure, the implementation of the apparatus may refer to the implementation of the method, and repeated parts will not be repeated.

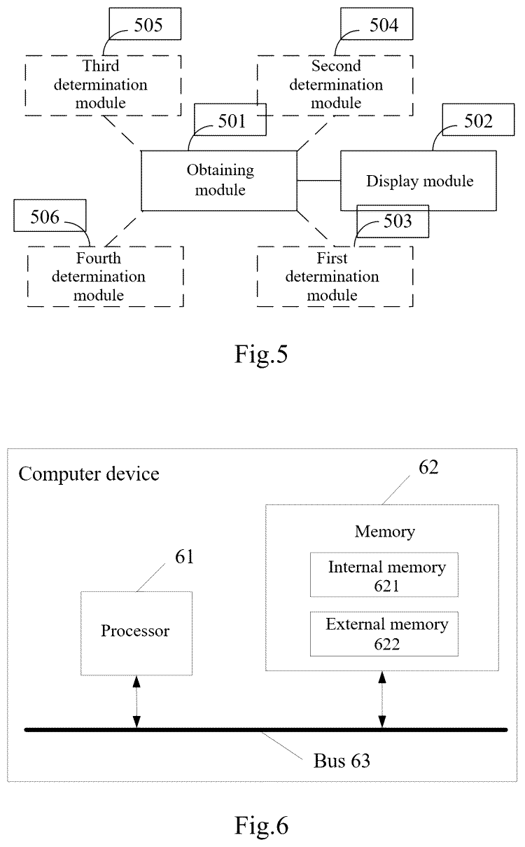

As shown in FIG. 5, which is a schematic diagram of an apparatus for displaying a page tool according to an embodiment of the present disclosure, the apparatus includes:
an obtaining module 501, configured to obtain a search result matching search information and a plurality of target tool buttons associated with the search information and/or the search result in response to receiving the search information, where the plurality of target tool buttons are determined based on at least one mounting dimension; and
a display module 502, configured to display the search result and the plurality of target tool buttons in a search result page and display a tool consumption page corresponding to a target tool after a target tool button is triggered.

In a possible implementation, the apparatus further includes:
a first determination module 503, configured to determine the mounting dimension according to:
determining at least one mounting dimension corresponding to the search result according to a content type of search content in the search result and an association relationship between a preset content type and the mounting dimension.

In a possible implementation, the mounting dimension includes a daily consumption dimension; and the apparatus further includes:
a second determination module 504, configured to determine the target tool button in the daily consumption dimension according to:
selecting a first tool button from preset tool buttons according to a correlation between a preset tool corresponding to each preset tool button and the search information and/or the search result; and
determining the target tool button from the first tool button according to a usage amount of the preset tool corresponding to each first tool button within a preset time period.

In a possible implementation, the mounting dimension includes the content dimension. The apparatus further includes:
a third determination module 505, configured to determine the target tool button in the content dimension according to:
selecting a second tool button from preset tool buttons according to a correlation between a preset tool corresponding to each preset tool button and search content in the search result;
selecting a third tool button matching a historical search behavior from the second tool button according to various historical search behaviors related to the search information and obtained upon authorization;
determining target information flow content with views greater than a preset threshold according to views of each piece of information flow content within a preset time period; and
selecting the target tool button from the third tool button according to a correlation between each third tool button and the target information flow content.

In a possible implementation, the mounting dimension includes the functional dimension. The apparatus further includes:
a fourth determination module 506, configured to determine the target tool button in the functional dimension according to:
selecting a fourth tool button from preset tool buttons according to a search time period when the search information is input and a pre-established mapping relationship between a time period and a tool button; and
selecting a target tool button with a preset function from the fourth tool button according to a function of a preset tool corresponding to each fourth tool button.

In a possible implementation, after displaying the search result and the plurality of target tool buttons in the search result page, the display module 502 is further configured to:
in response to triggering any one of the target tool buttons, display a tool consumption page of a target tool corresponding to the target tool button, and display an associated tool button associated with the target tool at a preset position of the tool consumption page, where the associated tool button is determined according to a tool category and/or a function of the target tool.

In a possible implementation, the display module 502, when displaying the search result and the plurality of target tool buttons in the search result page, is configured to:
display the search result and the target tool buttons in a result display area of the search result page; or
display the search result in a result display area of the search result page, and display tool entrance corresponding to each of the target tool buttons in a recommendation area for displaying recommended search terms in the search result page, where the tool entrance is used to replace the recommended search terms displayed in the recommendation area.

For descriptions of processing flows of respective modules in the apparatus and interaction flows between the respective modules, reference may be made to the related descriptions in the above method embodiments, which will not be described in detail here.

Based on the same technical concept, an embodiment of the present disclosure further provides a computer device. Referring to FIG. 6, which is a schematic structural diagram of a computer device according to an embodiment of the present disclosure, the computer device includes:
a processor 61, a memory 62, and a bus 63. The memory 62 stores machine-readable instructions executable by the processor 61. The processor 61 is configured to execute the machine-readable instructions stored in the memory 62. When the machine-readable instructions are executed by the processor 61, the processor 61 executes: S101, obtaining a search result matching search information and a plurality of target tool buttons associated with the search information and/or the search result in response to receiving the search information, where the plurality of target tool buttons are determined based on at least one mounting dimension; and S102, displaying the search result and the plurality of target tool buttons in a search result page, and displaying a tool consumption page corresponding to a target tool after a target tool button is triggered.

The memory 62 includes an internal memory 621 and an external memory 622. The internal memory 621 is also referred to as an internal memory, and is used to temporarily store operation data in the processor 61 and data exchanged with the external memory 622 such as a hard disk. The processor 61 exchanges data with the external memory 622 through the internal memory 621. When the computer device is running, the processor 61 communicates with the memory 62 through the bus 63, so that the processor 61 executes the execution instructions mentioned in the above method embodiments.

An embodiment of the present disclosure further provides a computer-readable storage medium. The computer-readable storage medium is stored thereon with a computer program which, when run by a processor, performs the steps of the page tool display method described in the above method embodiments. The storage medium may be a volatile or non-volatile computer-readable storage medium.

A computer program product of the method for displaying the page tool according to an embodiment of the present disclosure includes a computer-readable storage medium storing program codes. Instructions included in the program codes may be used to perform the steps of the method for displaying the page tool described in the above method embodiments, which may be specifically referred to the above method embodiments and will not be repeated here.

The computer program product may be specifically implemented by hardware, software, or a combination thereof. In an optional embodiment, the computer program product is embodied as a computer storage medium, while in another optional embodiment, the computer program product is embodied as a software product, such as a software development kit (SDK) and so on.

It can be clearly understood by those skilled in the art that for the convenience and conciseness of description, for the specific working process of the above-described apparatus, reference may be made to the corresponding process in the foregoing method embodiments, which will not be repeated here. In the several embodiments provided in the present disclosure, it should be understood that the disclosed apparatus and method may be implemented in other manners. The above-described apparatus embodiments are merely illustrative. For example, the division of the units is merely a logical function division, and there may be other division manners in actual implementation. For another example, multiple units or components may be combined, or some features may be ignored or not implemented. In another point, the mutual coupling, direct coupling, or communication connection shown or discussed may be through some communication interfaces, and the indirect coupling or communication connection between the apparatuses or units may be electrical, mechanical, or other forms.

The units described as separate parts may or may not be physically separated, and the parts displayed as units may or may not be physical units, that is, they may be located in one place or may be distributed on multiple network units. Some or all of the units may be selected according to actual needs to achieve the objectives of the solutions of the embodiments.

In addition, respective functional units in the embodiments of the present disclosure may be integrated into one processing unit, or each unit may exist alone physically, or two or more units may be integrated into one unit.

If the functions are implemented in the form of software functional units and sold or used as independent products, they may be stored in a non-volatile computer-readable storage medium executable by a processor. Based on this understanding, the technical solutions of the present disclosure may be embodied in the form of a software product in essence, or a part of the technical solutions may be embodied in the form of a software product. The computer software product is stored in a storage medium and includes several instructions for causing a computer device (which may be a personal computer, a server, or a network device, etc.) to execute all or part of the steps of the methods described in the embodiments of the present disclosure. The aforementioned storage medium includes various media that can store program codes, such as a USB flash drive, a mobile hard disk, a read-only memory (ROM), a random access memory (RAM), a magnetic disk, or an optical disk.

If the technical solutions of the present disclosure involve personal information, a product implementing the technical solutions of the present disclosure has clearly informed the personal information processing rules and obtained personal consent before processing the personal information. If the technical solutions of the present disclosure involve sensitive personal information, a product implementing the technical solutions of the present disclosure has obtained individual consent and satisfied the “explicit consent” requirement before processing the sensitive personal information. For example, at a personal information collection apparatus such as a camera, a clear and conspicuous identification is set to inform that the personal information collection range has been entered and the personal information will be collected, and if an individual voluntarily enters the collection range, it is deemed that the individual consents to the collection of his/her personal information. Alternatively, in the case where the personal information processing rules are informed by using conspicuous identification/information on a personal information processing apparatus, the individual authorization is obtained by means of pop-up information or by asking the individual to upload his/her personal information by himself/herself, etc. The personal information processing rules may include information such as a personal information processor, a purpose of personal information processing, a processing method, and a type of personal information processed.

Finally, it should be noted that the above embodiments are only specific implementations of the present disclosure, which are used to illustrate the technical solutions of the present disclosure, but not to limit them. The protection scope of the present disclosure is not limited to this. Although the present disclosure has been described in detail with reference to the foregoing embodiments, those of ordinary skill in the art should understand that any person skilled in the art can still modify the technical solutions described in the foregoing embodiments or easily conceive changes, or equivalently replace some technical features therein within the technical scope disclosed in the present disclosure. These modifications, changes, or replacements do not make the essence of the corresponding technical solutions deviate from the spirit and scope of the technical solutions of the embodiments of the present disclosure, and all of them should be covered by the protection scope of the present disclosure. Therefore, the protection scope of the present disclosure should be subject to the protection scope of the claims.

1. A method for displaying page tool, comprising:
obtaining a search result matching search information and a plurality of target tool buttons associated with at least one selected from the group consisting of the search information and the search result in response to receiving the search information, wherein the plurality of target tool buttons are determined based on at least one mounting dimension; and
displaying the search result and the plurality of target tool buttons in a search result page, and displaying a tool consumption page corresponding to a target tool after the target tool button is triggered.

2. The method according to claim 1, wherein the mounting dimension is determined according to:
determining at least one mounting dimension corresponding to the search result according to a content type of search content in the search result and an association relationship between a preset content type and the mounting dimension.

3. The method according to claim 1, wherein the mounting dimension comprises a daily consumption dimension, and the target tool button in the daily consumption dimension is determined according to:
selecting a first tool button from a preset tool button according to a correlation between a preset tool corresponding to each preset tool button and at least one selected from the group consisting of the search information and the search result; and
determining the target tool button from the first tool button according to a usage amount of the preset tool corresponding to each first tool button within a preset time period.

4. The method according to claim 1, wherein the mounting dimension comprises a content dimension, and the target tool button in the content dimension is determined according to:
selecting a second tool button from a preset tool button according to a correlation between a preset tool corresponding to each preset tool button and search content in the search result;
selecting a third tool button matching a historical search behavior from the second tool button according to each historical search behavior related to the search information and obtained upon authorization;
determining target information flow content with views greater than a preset threshold according to the views of each piece of information flow content within a preset time period; and
selecting the target tool button from the third tool button according to a correlation between each third tool button and the target information flow content.

5. The method according to claim 1, wherein the mounting dimension comprises a functional dimension, and the target tool button in the functional dimension is determined according to:
selecting a fourth tool button from a preset tool button according to a search time period when the search information is input and according to a pre-established mapping relationship between a time period and a tool button; and
selecting a target tool button with a preset function from the fourth tool button according to a function of a preset tool corresponding to each fourth tool button.

6. The method according to claim 1, wherein after the displaying the search result and the plurality of target tool buttons in a search result page, the method further comprises:
in response to triggering a first target tool button of the target tool buttons, displaying a tool consumption page of a target tool corresponding to the first target tool button, and displaying an associated tool button associated with the target tool at a preset position of the tool consumption page, wherein the associated tool button is determined according to at least one selected from the group consisting of a tool category and a function of the target tool.

7. The method according to claim 1, wherein the displaying the search result and the plurality of target tool buttons in a search result page comprises:
displaying the search result and the target tool buttons in a result display area of the search result page; or
displaying the search result in a result display area of the search result page, and displaying a tool entrance corresponding to each of the target tool buttons in a recommendation area for displaying recommended search terms in the search result page, wherein the tool entrance is used to replace the recommended search terms displayed in the recommendation area.

8. (canceled)

9. A computer device, comprising: a memory and at least one processor, wherein the memory stores machine-readable instructions executable by the at least one processor, the at least one processor is configured to execute the machine-readable instructions stored in the memory, and when the machine-readable instructions are executed by the processor, the at least one processor executes a method for displaying page tool, the method for displaying page tool comprising:
obtaining a search result matching search information and a plurality of target tool buttons associated with at least one selected from the group consisting of the search information and the search result in response to receiving the search information, wherein the plurality of target tool buttons are determined based on at least one mounting dimension; and
displaying the search result and the plurality of target tool buttons in a search result page, and displaying a tool consumption page corresponding to a target tool after the target tool button is triggered.

10. A non-transitory computer-readable storage medium, wherein the computer-readable storage medium is stored thereon with a computer program, and when the computer program is run by a processor, the processor executes a method for displaying page tool, the method for displaying page tool comprising:
obtaining a search result matching search information and a plurality of target tool buttons associated with at least one selected from the group consisting of the search information and the search result in response to receiving the search information, wherein the plurality of target tool buttons are determined based on at least one mounting dimension; and
displaying the search result and the plurality of target tool buttons in a search result page, and displaying a tool consumption page corresponding to a target tool after the target tool button is triggered.

11. The computer device according to claim 9, wherein the mounting dimension is determined according to:
determining at least one mounting dimension corresponding to the search result according to a content type of search content in the search result and an association relationship between a preset content type and the mounting dimension.

12. The computer device according to claim 9, wherein the mounting dimension comprises a daily consumption dimension, and the target tool button in the daily consumption dimension is determined according to:
selecting a first tool button from a preset tool button according to a correlation between a preset tool corresponding to each preset tool button and at least one selected from the group consisting of the search information and the search result; and
determining the target tool button from the first tool button according to a usage amount of the preset tool corresponding to each first tool button within a preset time period.

13. The computer device according to claim 9, wherein the mounting dimension comprises a content dimension, and the target tool button in the content dimension is determined according to:
selecting a second tool button from a preset tool button according to a correlation between a preset tool corresponding to each preset tool button and search content in the search result;
selecting a third tool button matching a historical search behavior from the second tool button according to each historical search behavior related to the search information and obtained upon authorization;
determining target information flow content with views greater than a preset threshold according to the views of each piece of information flow content within a preset time period; and
selecting the target tool button from the third tool button according to a correlation between each third tool button and the target information flow content.

14. The computer device according to claim 9, wherein the mounting dimension comprises a functional dimension, and the target tool button in the functional dimension is determined according to:
selecting a fourth tool button from a preset tool button according to a search time period when the search information is input and according to a pre-established mapping relationship between a time period and a tool button; and
selecting a target tool button with a preset function from the fourth tool button according to a function of a preset tool corresponding to each fourth tool button.

15. The computer device according to claim 9, wherein after the displaying the search result and the plurality of target tool buttons in a search result page, the is further configured to:
in response to triggering a first target tool button of the target tool buttons, display a tool consumption page of a target tool corresponding to the first target tool button, and display an associated tool button associated with the target tool at a preset position of the tool consumption page, wherein the associated tool button is determined according to at least one selected from the group consisting of a tool category and a function of the target tool.

16. The computer device according to claim 9, wherein the displaying the search result and the plurality of target tool buttons in a search result page comprises:
displaying the search result and the target tool buttons in a result display area of the search result page; or
displaying the search result in a result display area of the search result page, and displaying a tool entrance corresponding to each of the target tool buttons in a recommendation area for displaying recommended search terms in the search result page, wherein the tool entrance is used to replace the recommended search terms displayed in the recommendation area.

17. The non-transitory computer-readable storage medium according to claim 10, wherein the mounting dimension is determined according to:
determining at least one mounting dimension corresponding to the search result according to a content type of search content in the search result and an association relationship between a preset content type and the mounting dimension.

18. The non-transitory computer-readable storage medium according to claim 10, wherein the mounting dimension comprises a daily consumption dimension, and the target tool button in the daily consumption dimension is determined according to:
selecting a first tool button from a preset tool button according to a correlation between a preset tool corresponding to each preset tool button and at least one selected from the group consisting of the search information and the search result; and
determining the target tool button from the first tool button according to a usage amount of the preset tool corresponding to each first tool button within a preset time period.

19. The non-transitory computer-readable storage medium according to claim 10, wherein the mounting dimension comprises a content dimension, and the target tool button in the content dimension is determined according to:
selecting a second tool button from a preset tool button according to a correlation between a preset tool corresponding to each preset tool button and search content in the search result;
selecting a third tool button matching a historical search behavior from the second tool button according to each historical search behavior related to the search information and obtained upon authorization;
determining target information flow content with views greater than a preset threshold according to the views of each piece of information flow content within a preset time period; and
selecting the target tool button from the third tool button according to a correlation between each third tool button and the target information flow content.

20. The non-transitory computer-readable storage medium according to claim 10, wherein the mounting dimension comprises a functional dimension, and the target tool button in the functional dimension is determined according to:
selecting a fourth tool button from a preset tool button according to a search time period when the search information is input and according to a pre-established mapping relationship between a time period and a tool button; and
selecting a target tool button with a preset function from the fourth tool button according to a function of a preset tool corresponding to each fourth tool button.

21. The non-transitory computer-readable storage medium according to claim 10, wherein after the displaying the search result and the plurality of target tool buttons in a search result page, the is further configured to:
in response to triggering a first target tool button of the target tool buttons, display a tool consumption page of a target tool corresponding to the first target tool button, and display an associated tool button associated with the target tool at a preset position of the tool consumption page, wherein the associated tool button is determined according to at least one selected from the group consisting of a tool category and a function of the target tool.
